(19) United States
(12) Patent Application Publication
(10) Pub. No.: US 2012/0151207 A1
(43) Pub. Date: Jun. 14, 2012

(54) Method and System for Guiding Smart Antenna

(75) Inventors: Zhenli Zhao, Shenzhen City (CN); Jiejie Liu, Shenzhen City (CN)

(73) Assignee: ZTE CORPORATION, Shenzhen City Guangdong Province (CN)

(21) Appl. No.: 13/260,087

(22) PCT Filed: May 24, 2010
(86) PCT No.: PCT/CN10/73140

§ 371 Date: Feb. 17, 2012

(30) Foreign Application Priority Data
Aug. 31, 2009 (CN) 200910172069.1

(51) Int. Cl. H04W 12/00; H04W 84/12; H04W 64/00

(52) U.S. Cl. 713/156; 455/517

(57) ABSTRACT

A method and system for guiding smart antenna is provided. The method includes: a terminal accessing a WLAN Authentication and Privacy Infrastructure (WAPI) access point, acquiring a position information from the WAPI access point; the terminal directly sending the position information to a base station, and the base station obtaining a terminal position information according to the position information; or after the terminal obtains a terminal position information according to the position information, sending the terminal position information to the base station; the base station guiding the smart antenna by using the terminal position information. The method and system adopts a WAPI function to position the terminal, the implementation is simple and the startup time is very short.

### TECHNICAL FIELD

The present invention relates to the mobile communication system, and particularly, to a method and system for guiding a smart antenna.

### BACKGROUND OF THE RELATED ART

To solve the security holes existing in the WEP security mechanism as defined in the wireless local area network (WLAN) international standards ISO/IEC8802-11, our country has issued a wireless local area network national standards, which adopts the WLAN Authentication and Privacy Infrastructure (WAPI) security mechanism to solve the security problems of WLAN.

The WAPI security mechanism mainly comprises two parts of the WLAN Authentication Infrastructure (WAI) and the WLAN Privacy Infrastructure (WPI), wherein the WAI provides functions such as security policy negotiation, user identity authentication, key negotiation and access control, and so on. The WAPI certificate authentication protocol adopts the public key cryptography to complete peer two-way authentications of an Authentication Supplicant Entity (ASUE) and an Authenticator Entity (AE) through an Authentication Service Entity (ASE), which guarantees that legal users access legal networks, and meanwhile provides a shared Base Key (BK) for the key management protocol, thereby realizing the negotiation and distribution of keys available for the data communication session.

In the mobile communication system, the transceivers equipped by many base stations are usually connected to the antenna devices which provide a coverage area or “cell”. The common form of the antenna device comprises three antennas, and each antenna radiates energy in the angle of 120 degree to provide an all-around coverage range which the cell needs. As shown in FIG. 1, it is a schematic diagram of one cell in current conventional cellular communication system. The cell comprises a base station 17, and three antennas 11/12/13 which are connected to the base station and correspond to three sectors respectively, and further has corresponding mobile terminals (UE). The three antennas thereof are usually used to provide a coverage area of 360 degree which each cell needs, for example, the antenna ANT11 in FIG. 1 is responsible for providing signal coverage of 120 degree of the shadow area, and the users, UE14/15/16, only perform connection communication with this antenna. The disadvantage of this system is that the capacity is relatively limited, and the system performance cannot be improved according to the actual user amount and positions.

In order to improve the system performance and capacity, now a new-style communication system starts to use a smart antenna array. The smart antenna is an array of antenna elements, and each antenna element receives the signal which needs to be sent with a predetermined phase shift. The net effect of the array is in that the transmitting beam or receiving beam is guided to a predetermined direction, and the direction of the beams can be changed by controlling to excite the phase relation of the signals of the antenna array elements. Therefore, compared with the radiation energy of all the users in the predetermined coverage area by each conventional antenna, the smart antenna guides the beams into each individual user or multiple users. The smart antenna reduces the beam width and then reduces the interference to improve the system capacity. With the reduction of interference, the results of increasing the signal to interference ratio and signal to noise ratio can obtain the improved performance and capacity. In a power control system, as the performance requirement does not change basically, the transmitting power can be effectively reduced. As shown in FIG. 2, the smart antenna is an array of antenna elements 20-25, and the net effect of the array is to guide the transmitting beam or receiving beam to a predetermined direction (which is beneficial for the direction in which the UE is located). Each beam can be controlled by controlling the phase relation of the signals of the elements which are used for stimulating the array. Therefore, compared with the radiation energy of all the users in the predetermined coverage area by each conventional antenna, the smart antenna can guide the beams into each individual UE, for example, the individual beam corresponds to the UE26-29 respectively in the drawing. The smart antenna can reduce the interference by reducing the beam width, so as to improve the system capacity and performance.

Although the smart antenna can improve the capacity and performance effectively, one problem related to the use of the smart antenna is to position the user who will be guided for the given beam. In a reverse link, the position of the user is calculated, through a triangulation or other applicable techniques, by using an angle of arrival of the energy emitted by users. However, the current technique used to calculate the angle of arrival information is computationally intensive. In addition, the system is applicable for the environment which receives the energy from the user through a straight line. And in the urban environment, as signals are usually reflected or received as a multi-path wave velocity by mansions or other buildings, such condition is usually not true.

Therefore, in this new-style mobile communication system, it still needs an apparatus and method for improving the system capacity. Furthermore, the cellular phone communication system which uses the smart antenna needs a better method or apparatus for determining the position of the user who will be guided in the system.

In the related art, a Chinese patent application, of which the patent application number is 01818901.6, is “a method and apparatus for guiding narrow beam antenna by positioning”, this patent mainly adopts a method of receiving the Global Positioning System (GPS) signal to determine the position of the user in the system. The disadvantage of this patent is that: the startup time of the GPS device is longer, and particularly for a cold startup, the time of 40s is at least needed, which limits the effective application of this technique.

### SUMMARY OF THE INVENTION

The technical problem to be solved by the present invention is to provide a method and system for guiding a smart antenna, the implementation of which is simple, and the present invention can position the users effectively, thereby guiding the smart antenna.

In order to solve the above problem, the present invention provides a method for guiding a smart antenna, which comprises:

a terminal accessing a Wireless Local Area Network Authentication and Privacy Infrastructure (WAPI) access point, and acquiring a position information from said WAPI access point;

the terminal directly sending said position information to a base station, and the base station obtaining a terminal position information according to said position information; or the terminal obtaining a terminal position information according to said position information, and sending the terminal position information to the base station; and

the base station guiding the smart antenna by using said terminal position information.

The above method can further have features as follows: said position information is a WAPI access point position information; and the step of said base station obtaining the terminal position information according to said position information comprises: the base station taking said WAPI access point position information as said terminal position information.

The above method can further have features as follows: said position information is a WAPI access point position information; and said method further comprises: said terminal also acquiring a signal strength information between said terminal and said WAPI access point, and sending said signal strength information and said WAPI access point position information to said base station together; and the step of said base station obtaining the terminal position information according to said position information comprises: said base station determining the terminal position information according to said signal strength information and said WAPI access point position information.

The above method can further have features as follows: said position information is a WAPI access point position information; and the step of said terminal obtaining a terminal position information according to said position information comprises: said terminal also acquiring a signal strength information between said terminal and said WAPI access point, and determining said terminal position information according to said signal strength information and said WAPI access point position information.

The above method can further have features as follows: said position information is a terminal position information; and the step of said terminal acquiring a position information from said WAPI access point comprises: said WAPI access point acquiring a signal strength information between said WAPI access point and said terminal, and determining the terminal position information according to the WAPI access point position information and said signal strength information and then sending to said terminal.

The above method further comprises: said terminal performing a certificate authentication process with said WAPI access point when accessing said WAPI access point, and generating a group of base keys when the authentication succeeds;

wherein, the step of said terminal acquiring one position information from said WAPI access point comprises:

said WAPI access point encrypting said position information by using said base key and then sending to said terminal, and said terminal decrypting by using said base key, and obtaining said position information.

The present invention further provides a system for guiding a smart antenna, which comprises a terminal, a Wireless Local Area Network Authentication and Privacy Infrastructure (WAPI) access point and a base station, wherein:

said terminal is configured to: access the WAPI access point, and acquire a position information from said WAPI access point; directly send said position information to the base station, or obtain a terminal position information according to said position information, and send the terminal position information to the base station;

said WAPI access point is configured to: send said position information to said terminal;

said base station is configured to: obtain a terminal position information according to said position information, and guide the smart antenna by using said terminal position information; or, is configured to directly receive said terminal position information from said terminal, and guide the smart antenna by using said terminal position information.

The above system can further have features as follows: said WAPI access point is configured to: take a WAPI access point position information as said position information to send to the terminal;

said terminal is further configured to: acquire a signal strength information between said terminal and said WAPI access point, and send said signal strength information and said WAPI access point position information to said base station together;

said base station is configured to obtain the terminal position information by the following way: taking said WAPI access point position information as the terminal position information; or, determining the terminal position information according to said signal strength information and said WAPI access point position information.

The above system can further have features as follows: said WAPI access point is configured to: take a WAPI access point position information as said position information to send to the terminal;

said terminal is further configured to: acquire a signal strength information between said terminal and said WAPI access point, and determine said terminal position information according to said signal strength information and said WAPI access point position information.

The above system can further have features as follows: said WAPI access point is configured to: acquire the signal strength information between said WAPI access point and said terminal, determine the terminal position information according to said WAPI access point position information and said signal strength information, and take said terminal position information as said position information to send to said terminal.

The above system can further have features as follows: said terminal is further configured to: perform a certificate authentication process with said WAPI access point when accessing said WAPI access point, and generate a group of base keys when the authentication succeeds; receive from said WAPI access point the position information which is encrypted by using said base key, decrypt by using said base key, and obtain said position information;

said WAPI access point is configured to: perform the certificate authentication process with said terminal, and generate a group of base keys when the authentication succeeds, and encrypt said position information by using said base key and then send to said terminal.

The present invention adopts the WAPI function to position, the implementation is simple and the startup time is very short. In addition, the authentication ability of the WAPI is also an advantage of the present invention, which can guarantee the security of data and prevent that a normal operation of the system is interfered maliciously by using the wrong location information.

### BRIEF DESCRIPTION OF DRAWINGS

FIG. 1 is a schematic diagram of an existing conventional cellular communication system cell;

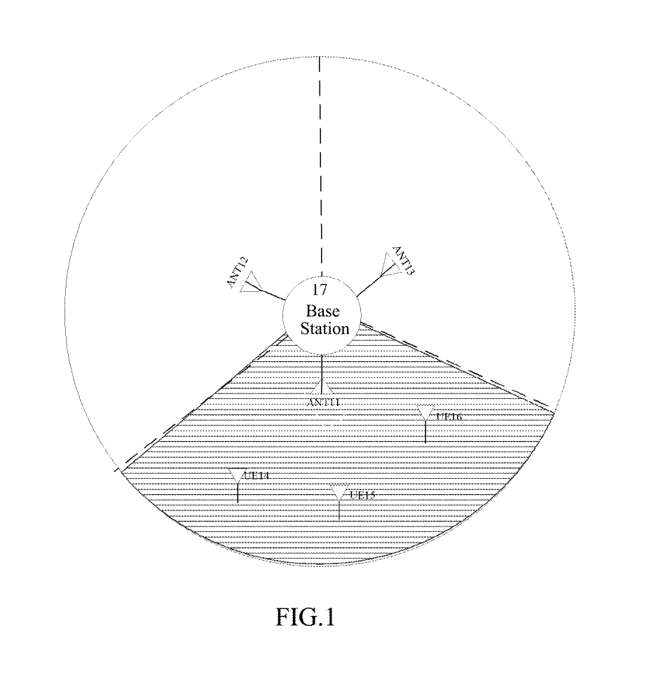

FIG. 2 is a schematic diagram of a cell after introducing a smart antenna;

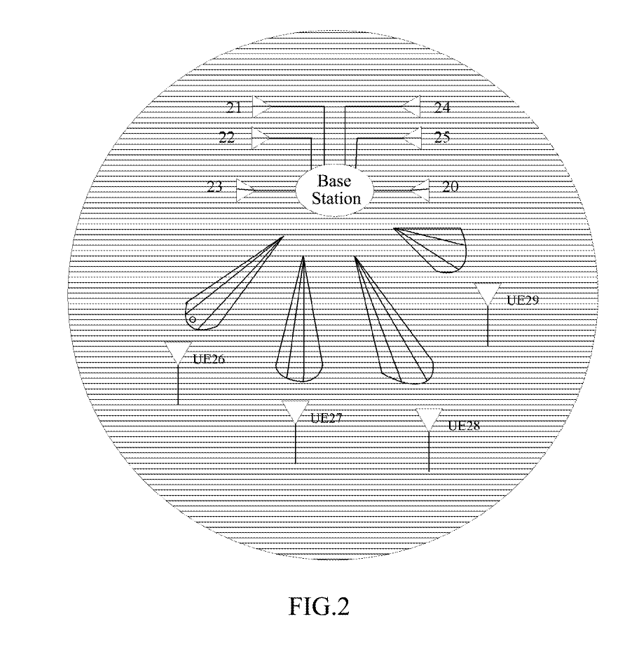

FIG. 3 is a block diagram of a system for guiding a smart antenna according to the present invention;

FIG. 4 is a flow chart of a method for UE guiding a smart antenna according to the present invention;

FIG. 5 is a flow chart of a WAPI certificate authentication process; and

FIG. 6 is a schematic diagram of a base station controlling the direction of smart antenna beam.

### PREFERRED EMBODIMENTS OF THE PRESENT INVENTION

Below the preferred embodiments of the present invention will be illustrated in detail in combination with the drawings.

The main idea of the present invention is to position a terminal according to the position information of an Access Point (AP) of the WAPI, thereby guiding the smart antenna.

The coverage range of the existing AP of the WAPI can just reach 100 meters at most. Therefore, a mobile communication terminal with a WAPI function can know that the position of the terminal is within the coverage range of radius of 100 meters of the AP after accessing to a certain AP. This accuracy has already satisfied the requirement for the beam positioning of the smart antenna. As each access point can provide its own position information, the mobile terminal can provide the position information of the AP for a base station after accessing the AP of the WAPI, also that is, provide its own rough position information. In addition, the distance from the mobile communication terminal to the AP can further be determined through the signal strength after accessing the WAPI, so as to further precisely determine the position information of the WAPI terminal.

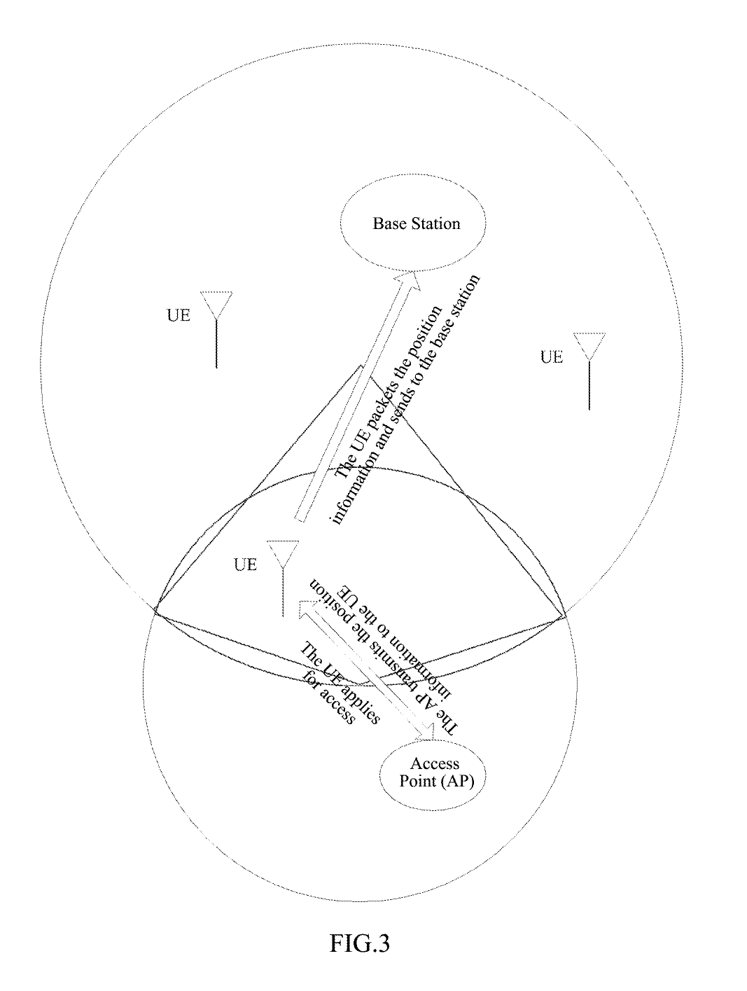

As shown in FIG. 3, a system for guiding the smart antenna in the present invention comprises: a base station with a smart antenna system, and a WAPI AP and a mobile terminal (UE) which supports WAPI functions, wherein:

the mobile terminal (UE) is configured to, after accessing the AP, send out a position information application to the AP through the WAPI function, and packet the received position information of the AP and forward to the base station; can further be configured to acquire a signal strength information between the UE and the AP, and send the signal strength information and the AP position information to the base station together; can further be configured to determine the position information of the terminal according to the signal strength information and the position information of the AP, and send the position information of the terminal to the base station; and can further be configured to directly receive from the AP the terminal position information (namely, the terminal position information determined by the AP side according to the AP position information and the signal strength information) and then send to the base station;

wherein, the signal strength information is one signal strength level information.

The WAPI access point is configured to receive the position information application of the mobile terminal and response to the position information application, and provide its own position information to this mobile terminal according to a certain format; or is configured to determine the terminal position information according to its own position information and a signal strength information between the WAPI access point and the terminal, and send the terminal position information to the terminal; wherein, the position information is encrypted between the WAPI access point and the terminal by using base keys.

The base station is configured to receive the position information of the AP from the mobile terminal, determine the terminal position information according to the position information of the AP, and guide the smart antenna by using the terminal position information; or directly receive the terminal position information from the terminal, and guide the smart antenna by using the terminal position information.

Wherein, the step of determining the position information of the terminal according to the position information of the AP specifically comprises, taking the position information of the AP as the position information of the terminal directly, or receiving the position information of the AP and the signal strength information from the mobile terminal, and determining the position information of the terminal by using the position information of the AP and the signal strength information; and guiding the smart antenna by using the position information of the terminal;

in addition, the base station also has a mechanical device which is used to response and receive the position information to guide the beam. This mechanical device comprises an antenna array and a smart antenna system of a beam generation network which is used for stimulating this array to output the guided beam.

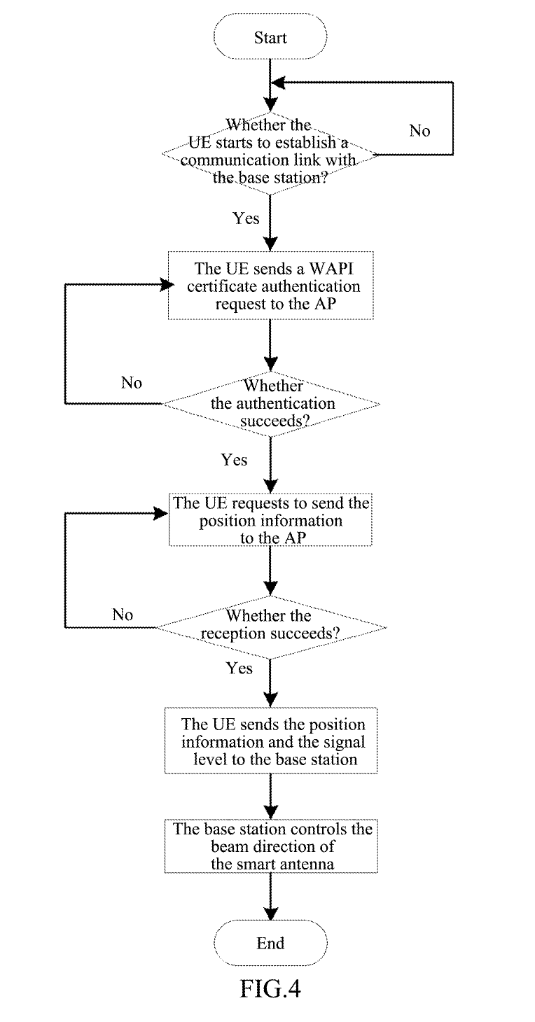

Below the entire process of the mobile communication terminal guiding the latest smart antenna beam in the communication system through the WAPI function will be analyzed with reference to FIG. 4. When the UE needs to establish a communication link (such as the calling or the called), the smart antenna beam in the system needs to direct to this UE, and thus the position information of the UE is needed; and in the present invention, the terminal actively reports its own position information.

A method for guiding the smart antenna provided in the present invention comprises the steps:

firstly, the UE accesses the AP and acquires the position information of the AP from the AP;

when the UE accesses the AP, a certificate authentication process is performed between the UE and the AP; the UE sends a WAPI certificate authentication request to the AP (or a router), and only when the AP authenticates successfully, the UE can be permitted to perform further network accessing (a specific authentication process is described vide post). After the authentication succeeds, the UE and AP will generate a group of consistent Base Keys (BK).

After the authentication succeeds, the UE sends a request message to the AP and requests the AP to send the position information of AP to the UE, and the AP, after receiving the request message, encrypts its own position information by using the base key and then transmits to the UE; or, the AP obtains the terminal position information according to its own position information and the signal strength information between the AP and the terminal, encrypts the terminal position information by using the base key and then transmits to the UE.

The UE receives the position information of the AP and decrypts according to the determined base key, and then acquires the position information of the AP; or the UE receives the terminal position information and decrypts according to the determined base key, and acquires the terminal position information.

Furthermore, the UE can extract its own WAPI signal strength, and determine its own signal strength level at the time according to a predetermined signal strength level (such as the three levels of strong, medium and weak, or other levels). The signal strength level indicates the distance from the UE to the AP, and the stronger the signal strength is, the closer the distance between the UE and the AP is, whereas the farther the distance is.

Then, the UE packs and encrypts the position information of the AP according to a certain format, and sends the packet to the base station; or, the base station packs and encrypts the received position information of the AP and the signal strength level information according to a certain format, and sends the packet to the base station; or, the terminal determines its own position information according to the position information of the AP and the signal strength level information, packs and encrypts its own position information according to a certain format, and sends the packet to the base station; or, the terminal packs and encrypts the terminal position information received from the AP according to a certain format, and sends the packet to the base station;

finally, the base station receives the position information of the AP from the mobile terminal, determines the terminal position information according to the position information of the AP, and guide the smart antenna by using the terminal position information; or, directly receives the terminal position information from the terminal, and guide the smart antenna by using the terminal position information.

Wherein, the determining the terminal position information according to the position information of the AP specifically comprises, directly taking the position information of the AP as the terminal position information, or receiving the position information of the AP and the signal strength information from the mobile terminal, and determining the terminal location information by using the position information of the AP and the signal strength information.

The method for guiding the smart antenna specifically comprises: a base station receiver transmitting the received information to a spatial processor, the spatial processor controlling a beam generator to generate a beam control signal, and the smart antenna adjusting the direction of the beam according to the beam control signal and being guided to the position in which the UE is located.

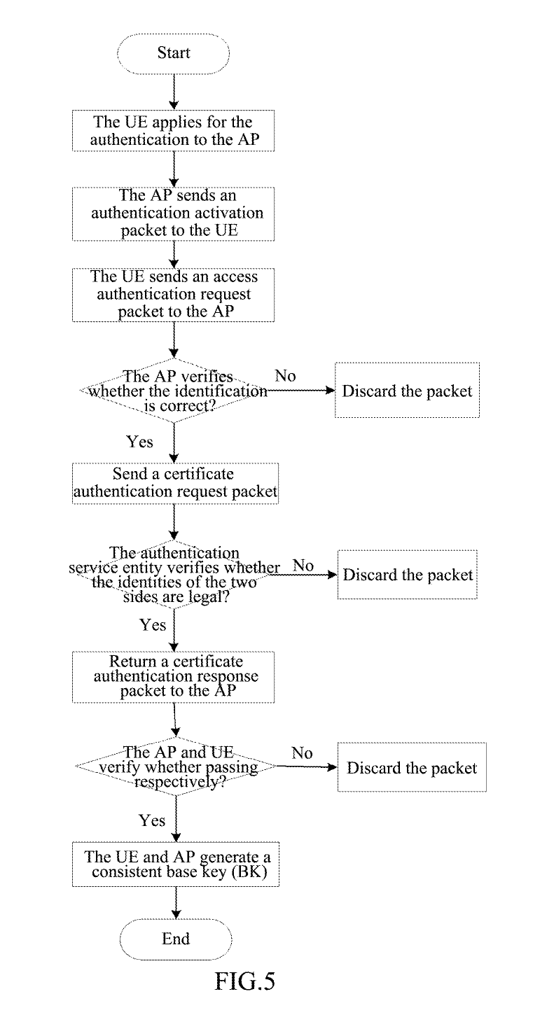

FIG. 5 is a WAPI authentication process in the present invention, which specifically comprises:

(1) when the UE associates or re-associates with the AP, the AP sends an authentication activation packet to the UE, and the authentication activation packet includes an authentication identification;

(2) the UE will send an access authentication request packet to the AP after receiving the authentication activation packet, and the packet includes an authentication identification, a temporary public key and certificate of the UE, and a signature which is made by the UE for the foregoing fields by using a long-term private key;

(3) the AP will perform a verification after receiving the request, and if the identification is correct, the AP sends a certificate authentication request packet to an authentication service entity, otherwise, discards this packet, wherein the certificate authentication request packet includes the authentication identification and the public keys and signatures of the two sides;

(4) afterwards, the authentication service entity will verify whether the identities of the two sides are legal, and if the identities of the two sides are legal, the authentication service entity returns an certificate authentication response packet to the AP, otherwise, discards this packet;

(5) the AP verifies whether the response packet is correct after receiving the response packet, and if the response packet is correct, the AP informs the UE to keep on the verification, otherwise, discards this packet, and if the UE also passes the verification in the following, the two sides will obtain the temporary public key of the opposite side;

(6) the UE and the AP perform a calculation according to a temporary public key of the opposite side and a local temporary private key, and generate the consistent Base Key (BK); and the entire authentication process ends.

The duration time of the above entire authentication and verification process is about 1s.

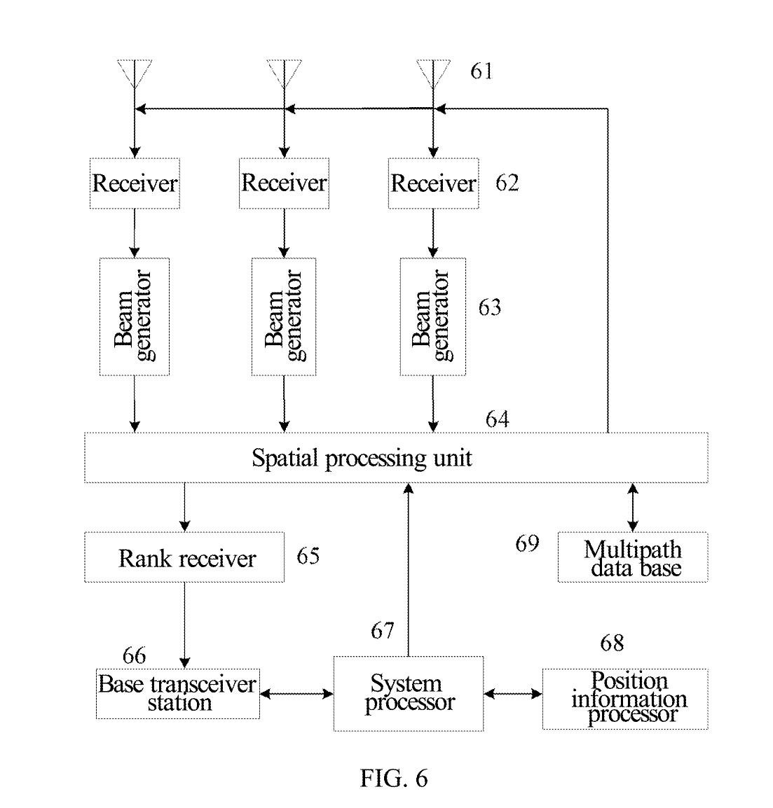

FIG. 6 shows a schematic diagram of the control process of the smart antenna system in combination with the principle of the present invention. The smart antenna system comprises a smart antenna array and a smart antenna processing circuit, wherein, the smart antenna array consists of antenna radiation elements 61, and the smart antenna processing circuit consists of a plurality of receivers 62, a plurality of beam generators 63, a spatial processing unit 64 and a rank receiver 65. As shown in FIG. 6, the n antenna elements 61 of the antenna array are respectively connected to n corresponding receivers 62, and each receiver performs a down-conversion and demodulation to the signals received by the antenna and performs a matched filtering correspondingly, that is, transforms the received radio-frequency signals to an original baseband signals.

Then, the baseband signals output by the receiver are transmitted to the beam generator 63; the beam generation process includes multiplication and addition operation, each beam needs this operation, and generally each user has a plurality of beams existing in a plurality of users. The signals after the addition are provided to the rank receiver 65; and the rank receiver receives the output of the beam generator, and then relays and combines these signals with an optimal form, wherein this operation occurs under the control of the spatial processing unit 64. The spatial processing unit is responsible for determining the features of the beam which is to be formed, that is, determining the gain and phase of the antenna array. The system processor 67 processes the data transmitted from the position information processor 68, and then forwards to the spatial processing unit 64, which is used for uninterruptedly adjusting the features of the beam. Optionally, the information provided by the multipath data base 69 is adopted to calculate the direction of the beam, and the data base either can be based on the analysis for the environment or can be based on the implemented measurement.

If the user does not report the position in which it is located successfully due to various reasons, the system can compatibly adopt an algorithm of producing the pattern covering the entire sector.

It should be understood that, for those ordinary skilled in the art to which the present invention technique belongs, the corresponding equivalent changes or substitutions can be made according to the technical scheme and conception of the present invention, and all these changes or substitutions should all fall into the protection scope of the appending claims of the present invention.

### INDUSTRIAL APPLICABILITY

The present invention adopts the WAPI function to position, the implementation is simple and the startup time is very short. In addition, the authentication ability of the WAPI is also an advantage of the present invention, which can guarantee the security of data and prevent that a normal operation of the system is interfered maliciously by using the wrong location information.

1. A method for guiding a smart antenna, comprising:
a terminal accessing a Wireless Local Area Network Authentication and Privacy Infrastructure (WAPI) access point, and acquiring a position information from said WAPI access point;
the terminal directly sending said position information to a base station, and the base station obtaining a terminal position information according to said position information; or the terminal obtaining a terminal position information according to said position information, and sending the terminal position information to the base station; and
the base station guiding the smart antenna by using said terminal position information.

2. The method according to claim 1, wherein,
said position information is a WAPI access point position information;
the step of said base station obtaining the terminal position information according to said position information comprises: the base station taking said WAPI access point position information as said terminal position information.

3. The method according to claim 1, wherein,
said position information is a WAPI access point position information;
said method further comprises: said terminal acquiring a signal strength information between said terminal and said WAPI access point, and sending said signal strength information and said WAPI access point position information to said base station together;
the step of said base station obtaining the terminal position information according to said position information comprises: said base station determining the terminal position information according to said signal strength information and said WAPI access point position information.

4. The method according to claim 1, wherein,
said position information is a WAPI access point position information;
the step of said terminal obtaining the terminal position information according to said position information comprises: said terminal acquiring a signal strength information between said terminal and said WAPI access point, and determining said terminal position information according to said signal strength information and said WAPI access point position information.

5. The method according to claim 1, wherein,
said position information is a terminal position information;
the step of said terminal acquiring one position information from said WAPI access point comprises: said WAPI access point acquiring a signal strength information between said WAPI access point and said terminal, and determining the terminal position information according to the WAPI access point position information and said signal strength information and then sending the terminal position information to said terminal.

6. The method according to claim 1, further comprising: said terminal performing a certificate authentication process with said WAPI access point when accessing said WAPI access point, and generating a group of base keys when the authentication succeeds;
wherein, the step of said terminal acquiring one position information from said WAPI access point comprises:
said WAPI access point encrypting said position information by using said base key and then sending to said terminal, and said terminal decrypting by using said base key, and obtaining said position information.

7. A system for guiding a smart antenna, comprising a terminal, a Wireless Local Area Network Authentication and Privacy Infrastructure (WAPI) access point and a base station, wherein:
said terminal is configured to: access the WAPI access point, and acquire a position information from said WAPI access point; directly send said position information to the base station, or obtain a terminal position information according to said position information, and send the terminal position information to the base station;
said WAPI access point is configured to: send said position information to said terminal;
said base station is configured to: obtain a terminal position information according to said position information, and guide the smart antenna by using said terminal position information; or, is configured to directly receive said terminal position information from said terminal, and guide the smart antenna by using said terminal position information.

8. The system according to claim 7, wherein,
said WAPI access point is configured to: take a WAPI access point position information as said position information to send to the terminal;
said terminal is further configured to: acquire a signal strength information between said terminal and said WAPI access point, and send said signal strength information and said WAPI access point position information to said base station together;
said base station is configured to obtain the terminal position information by the following way: taking said WAPI access point position information as the terminal position information; or, determining the terminal position information according to said signal strength information and said WAPI access point position information.

9. The system according to claim 7, wherein,
said WAPI access point is configured to: take a WAPI access point position information as said position information to send to the terminal;
said terminal is further configured to: acquire a signal strength information between said terminal and said WAPI access point, and determine said terminal position information according to said signal strength information and said WAPI access point position information.

10. The system according to claim 7, wherein,
said WAPI access point is configured to: acquire the signal strength information between said WAPI access point and said terminal, determine the terminal position information according to said WAPI access point position information and said signal strength information, and take said terminal position information as said position information to send to said terminal.

11. The system according to claim 7, wherein,
said terminal is further configured to: perform a certificate authentication process with said WAPI access point when accessing said WAPI access point, and generate a group of base keys when the authentication succeeds; receive from said WAPI access point said position information which is encrypted by using said base key, decrypt by using said base key, and obtain said position information;
said WAPI access point is configured to: perform the certificate authentication process with said terminal, and generate a group of base keys when the authentication succeeds, and encrypt said position information by using said base key and then send to said terminal.

12. The method according to claim 2, further comprising: said terminal performing a certificate authentication process with said WAPI access point when accessing said WAPI access point, and generating a group of base keys when the authentication succeeds;
wherein, the step of said terminal acquiring one position information from said WAPI access point comprises:
said WAPI access point encrypting said position information by using said base key and then sending to said terminal, and said terminal decrypting by using said base key, and obtaining said position information.

13. The method according to claim 3, further comprising: said terminal performing a certificate authentication process with said WAPI access point when accessing said WAPI access point, and generating a group of base keys when the authentication succeeds;
wherein, the step of said terminal acquiring one position information from said WAPI access point comprises:
said WAPI access point encrypting said position information by using said base key and then sending to said terminal, and said terminal decrypting by using said base key, and obtaining said position information.

14. The method according to claim 4, further comprising: said terminal performing a certificate authentication process with said WAPI access point when accessing said WAPI access point, and generating a group of base keys when the authentication succeeds;
wherein, the step of said terminal acquiring one position information from said WAPI access point comprises:
said WAPI access point encrypting said position information by using said base key and then sending to said terminal, and said terminal decrypting by using said base key, and obtaining said position information.

15. The method according to claim 5, further comprising: said terminal performing a certificate authentication process with said WAPI access point when accessing said WAPI access point, and generating a group of base keys when the authentication succeeds;
wherein, the step of said terminal acquiring one position information from said WAPI access point comprises:
said WAPI access point encrypting said position information by using said base key and then sending to said terminal, and said terminal decrypting by using said base key, and obtaining said position information.

16. The system according to claim 8, wherein,
said terminal is further configured to: perform a certificate authentication process with said WAPI access point when accessing said WAPI access point, and generate a group of base keys when the authentication succeeds; receive from said WAPI access point said position information which is encrypted by using said base key, decrypt by using said base key, and obtain said position information;
said WAPI access point is configured to: perform the certificate authentication process with said terminal, and generate a group of base keys when the authentication succeeds, and encrypt said position information by using said base key and then send to said terminal.

17. The system according to claim 9, wherein,
said terminal is further configured to: perform a certificate authentication process with said WAPI access point when accessing said WAPI access point, and generate a group of base keys when the authentication succeeds; receive from said WAPI access point said position information which is encrypted by using said base key, decrypt by using said base key, and obtain said position information;
said WAPI access point is configured to: perform the certificate authentication process with said terminal, and generate a group of base keys when the authentication succeeds, and encrypt said position information by using said base key and then send to said terminal.

18. The system according to claim 10, wherein,
said terminal is further configured to: perform a certificate authentication process with said WAPI access point when accessing said WAPI access point, and generate a group of base keys when the authentication succeeds; receive from said WAPI access point said position information which is encrypted by using said base key, decrypt by using said base key, and obtain said position information;
said WAPI access point is configured to: perform the certificate authentication process with said terminal, and generate a group of base keys when the authentication succeeds, and encrypt said position information by using said base key and then send to said terminal.
